(19) United States
(12) Patent Application Publication
(10) Pub. No.: US 2026/0296433 A1
(43) Pub. Date: Oct. 1, 2026

(54) VEHICLE CONTROL DEVICE, VEHICLE CONTROL METHOD, AND PROGRAM

(71) Applicant: HONDA MOTOR CO., LTD., Tokyo (JP)

(72) Inventors: Yuki Kitamura, Tokyo (JP); Yuki Ichino, Tokyo (JP)

(21) Appl. No.: 19/551,680

(22) Filed: Feb. 27, 2026

(30) Foreign Application Priority Data
Mar. 26, 2025 (JP) 2025-051459

(51) Int. Cl. B60W 30/18; B60W 30/12

(52) U.S. Cl. CPC B60W 30/18145; B60W 30/12; B60W 2552/30

(57) ABSTRACT

A vehicle control device includes: a recognition unit that recognizes a curve of a travel lane of a self-vehicle; and a control unit that performs, when the recognition unit detects that the self-vehicle is likely to depart from the curve of the travel lane, a curve departure mitigation control of the self-vehicle and determines an end possibility of the curve departure mitigation control, wherein the control unit determines the end possibility by an undershoot state in which a departure state of the self-vehicle is equal to or more than a predetermined state and an overshoot state in which the departure state of the self-vehicle is equal to or less than the predetermined state, and determines the end possibility based on a vehicle body end portion of the self-vehicle and a departure-side lane line of the travel lane which is at a minimal distance with respect to the vehicle body end portion.

### CROSS-REFERENCE TO RELATED APPLICATION

Priority is claimed on Japanese Patent Application No. 2025-051459, filed on Mar. 26, 2025, the contents of which are incorporated herein by reference.

### BACKGROUND

### Field of the Invention

The present invention relates to a vehicle control device, a vehicle control method, and a program.

### Background

In recent years, there have been increasing attempts to provide access to a sustainable transportation system that takes vulnerable traffic participants into consideration. In order to realize this effort, research and development relating to preventive safety techniques have been focused on in order to further improve road safety and convenience. For example, a device that gradually decreases a control amount at the end of a control that mitigates the road departure of a vehicle has been disclosed (for example, refer to Japanese Unexamined Patent Application, First Publication No. 2024-118722).

### SUMMARY

In the device of the related art, a condition of ending the control that mitigates the road departure of the vehicle has not been sufficiently studied.

An aspect of the present invention aims at providing a vehicle control device, a vehicle control method, and a program that can appropriately end a mitigation control of road departure. As described above, the aspect of the present invention improves preventive safety techniques and eventually contributes to development of sustainable transportation systems.

A vehicle control device according to a first aspect of the present invention includes: a recognition unit that recognizes a curve of a travel lane of a self-vehicle; and a control unit that performs, when the recognition unit detects that the self-vehicle is likely to depart from the curve of the travel lane, a curve departure mitigation control of the self-vehicle and determines an end possibility of the curve departure mitigation control, wherein the control unit determines the end possibility by an undershoot state in which a departure state of the self-vehicle is equal to or more than a predetermined state and an overshoot state in which the departure state of the self-vehicle is equal to or less than the predetermined state, and determines the end possibility based on a vehicle body end portion of the self-vehicle and a departure-side lane line of the travel lane which is at a minimal distance with respect to the vehicle body end portion.

A second aspect is the vehicle control device according to the first aspect described above, wherein the control unit may determine that the curve departure mitigation control is ended due to the undershoot state when the distance between the vehicle body end portion and the departure-side lane line of the travel lane which is at the minimal distance is equal to or more than a first predetermined distance toward a departure side with respect to the lane line, and may determine that the curve departure mitigation control is ended due to the overshoot state when the distance between the vehicle body end portion and the departure-side lane line of the travel lane which is at the minimal distance is equal to or more than a second predetermined distance toward an opposite side of the departure side with respect to the lane line.

A third aspect is the vehicle control device according to the second aspect described above, wherein the control unit may start an end determination of the curve departure mitigation control by the overshoot state when the distance between the vehicle body end portion and the departure-side lane line of the travel lane which is at the minimal distance is less than a third predetermined distance toward the opposite side of the departure side with respect to the lane line.

A fourth aspect is the vehicle control device according to the second aspect described above, wherein the first predetermined distance and the second predetermined distance may be an identical value.

A fifth aspect is the vehicle control device according to the third aspect described above, wherein the third predetermined distance may be equal to or less than the second predetermined distance.

A vehicle control method according to a sixth aspect of the present invention includes: by way of a computer, recognizing a curve of a travel lane of a self-vehicle; performing a curve departure mitigation control of the self-vehicle when it is detected that the self-vehicle is likely to depart from the curve of the travel lane; and determining an end possibility of the curve departure mitigation control based on a vehicle body end portion of the self-vehicle and a departure-side lane line of the travel lane which is at a minimal distance with respect to the vehicle body end portion when determining the end possibility by an undershoot state in which a departure state of the self-vehicle is equal to or more than a predetermined state and an overshoot state in which the departure state of the self-vehicle is equal to or less than the predetermined state.

A seventh aspect of the present invention is a computer-readable non-transitory storage medium storing a program that causes a computer to: recognize a curve of a travel lane of a self-vehicle; perform a curve departure mitigation control of the self-vehicle when it is detected that the self-vehicle is likely to depart from the curve of the travel lane; and determine an end possibility of the curve departure mitigation control based on a vehicle body end portion of the self-vehicle and a departure-side lane line of the travel lane which is at a minimal distance with respect to the vehicle body end portion when determining the end possibility by an undershoot state in which the departure state of the self-vehicle is equal to or more than a predetermined state and an overshoot state in which the departure state of the self-vehicle is equal to or less than the predetermined state.

According to the first, sixth, and seventh aspects, the end determination of the curve departure mitigation control is made by the determination of the undershoot state or the overshoot state on the basis of the departure-side vehicle body end portion of the self-vehicle and the departure-side lane line of the travel lane which is at the minimal distance with respect to the vehicle body end portion. Even when the self-vehicle departs from the curve, by performing the determination on the basis of the nearest lane line, it is possible to prevent the end condition of the curve departure mitigation control from being immediately established by a departure angle of the curve. Further, by using the departure-side lane line as the basis, it is possible to uniform the determination of the overshoot and the undershoot. As a result, it becomes possible to appropriately end a mitigation control of road departure in a curve.

According to the second and fourth aspects, even when the vehicle departs from the curve, the determination can be uniformly made based on the distance on the basis of the departure-side lane line regardless of the speed, and the driving can be transferred to a driver.

According to the third and fifth aspects, the determination of the overshoot state is prevented from being established simultaneously with the start of the curve departure mitigation control. Thereby, it is possible to prevent an unintended establishment of the determination of the overshoot state.

### BRIEF DESCRIPTION OF THE DRAWINGS

FIG. 1 is a configuration view of a vehicle system using a vehicle control device according to an embodiment.

FIG. 2 is a view showing a control executed by a first departure control unit.

FIG. 3 is a view showing a control executed by a second departure control unit.

FIG. 4 is a view showing an undershoot state of a vehicle.

FIG. 5 is a view showing an overshoot state of the vehicle.

FIG. 6 is a view showing a determination method of the undershoot state.

FIG. 7 is a view showing another calculation method about a minimal distance between a vehicle body end portion and a lane line for determining the undershoot state.

FIG. 8 is a view showing a determination method of the overshoot state.

FIG. 9 is a view showing a condition for starting the determination of the overshoot state.

FIG. 10 is a view showing a condition for starting the determination of the overshoot state.

FIG. 11 is a view showing another calculation method about a minimal distance between a vehicle body end portion and a lane line for determining the overshoot state.

FIG. 12 is a flowchart showing an example of a flow of a determination of an end possibility of a curve departure mitigation control.

### DESCRIPTION OF EMBODIMENTS

### Embodiment

### Overall Configuration

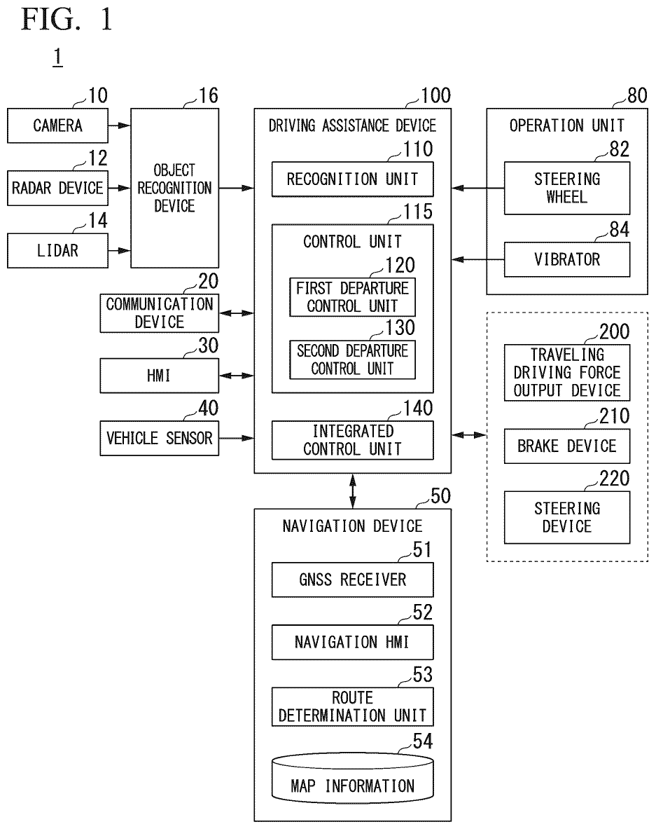

FIG. 1 is a configuration view of a vehicle system 1 using a vehicle control device according to an embodiment. A vehicle on which the vehicle system 1 is mounted is, for example, a two-wheeled, three-wheeled or four-wheeled vehicle, and a drive source thereof is an internal combustion engine such as a diesel engine or a gasoline engine, an electric motor, or a combination thereof. The electric motor is operated by using electric power generated by a generator connected to an internal combustion engine or electric power discharged from a secondary battery or a fuel cell.

The vehicle system 1 includes, for example, a camera 10, a radar device 12, a LIDAR (Light Detection and Ranging) 14, an object recognition device 16, a communication device 20, an HMI (Human Machine Interface) 30, a vehicle sensor 40, a navigation device 50, an operation unit 80, a driving assistance device 100, a traveling driving force output device 200, a brake device 210, and a steering device 220. These devices and equipment are connected to each other by a multiple communication line such as a CAN (Controller Area Network) communication line, a serial communication line, a wireless communication network, or the like. The configuration shown in FIG. 1 is merely an example, and part of the configuration may be omitted, or another configuration may be added. The driving assistance device 100 is an example of a “vehicle control device.”

The camera 10 is, for example, a digital camera using a solid-state imaging element such as a CCD (Charge Coupled Device) or a CMOS (Complementary Metal Oxide Semiconductor). The camera 10 is attached to an arbitrary portion of a vehicle (hereinafter, a vehicle M) on which the vehicle system 1 is mounted. When capturing an image in a forward direction, the camera 10 is attached to a front windshield upper portion, a rearview mirror back surface, or the like. For example, the camera 10 repeatedly captures an image around the vehicle M periodically. The camera 10 may be a stereo camera.

The radar device 12 emits radio waves such as millimeter waves to the surroundings of the vehicle M and detects radio waves (reflected waves) reflected by an object to detect at least the position (distance and azimuth) of the object. The radar device 12 is attached to an arbitrary portion of the vehicle M. The radar device 12 may detect the position and the speed of the object by a FM-CW (Frequency Modulated Continuous Wave) method.

The LIDAR 14 emits light (or electromagnetic waves having a wavelength close to light) to the surroundings of the vehicle M and measures scattered light. The LIDAR 14 detects the distance to a target on the basis of a time from light emission to light reception. The emitted light is, for example, a pulsed laser beam. The LIDAR 14 is attached to an arbitrary portion of the vehicle M.

The object recognition device 16 performs a sensor fusion process on a detection result by part or all of the camera 10, the radar device 12, and the LIDAR 14 and recognizes the position, the type, the speed, or the like, of the object. The object recognition device 16 outputs a recognition result to the driving assistance device 100. The object recognition device 16 may output the detection result of the camera 10, the radar device 12, and the LIDAR 14 to the driving assistance device 100 as it is. The object recognition device 16 may be omitted from a vehicle system 1.

The communication device 20 communicates with another vehicle that is present around the vehicle M, for example, by using a cellular network, a Wi-Fi network, Bluetooth (Registered trademark), DSRC (Dedicated Short-Range Communication), or the like or communicates with various server devices via a wireless base station.

The HMI 30 presents various information to an occupant of the vehicle M and accepts an input operation by the occupant. The HMI 30 includes, various display devices, a speaker, a buzzer, a touch panel, a switch, a key, and the like. The HMI 30 includes a display device. The display device (display portion) is, for example, a display device that displays various information in the vehicle M, that is a multi-information display, such as a speedometer indicating a travel speed of the vehicle M or a tachometer indicating a rotation speed of the internal combustion engine included in the vehicle M, the speed meter and the tachometer being provided on a center portion of an instrument panel of the vehicle M.

The vehicle sensor 40 includes a vehicle speed sensor that detects the speed of the vehicle M, an acceleration sensor that detects acceleration, a yaw rate sensor that detects an angular speed around a vertical axis, an azimuth sensor that detects an orientation of the vehicle M, and the like.

The navigation device 50 includes, for example, a GNSS (Global Navigation Satellite System) receiver 51, a navigation HMI 52, and a route determination unit 53. The navigation device 50 stores map information 54 in a storage device such as an HDD (Hard Disk Drive) or a flash memory. The GNSS receiver 51 specifies the position of the vehicle M on the basis of a signal received from a GNSS satellite. The position of the vehicle M may be specified or supplemented by an INS (Inertial Navigation System) using an output of the vehicle sensor 40. The navigation HMI 52 includes a display device, a speaker, a touch panel, a key, and the like. The navigation HMI 52 may be partially or wholly shared with the HMI 30 described above. For example, the route determination unit 53 determines a route (hereinafter, a route on a map) to a destination input by the occupant by using the navigation HMI 52 from the position (or an arbitrary position that is input) of the vehicle M specified by the GNSS receiver 51 with reference to the map information 54. The map information 54 is, for example, information in which a road shape is expressed by a link indicating a road and nodes connected by the link. The map information 54 may include a road curvature, POI (Point of Interest) information, and the like. The map information 54 includes, for example, information indicating a specified speed (for example, the speed limit or the legal speed) for each link indicating a road. The specified speed is information indicating, for example, the speed limit and the legal speed displayed on a road, a signboard provided on a road, or the like.

The navigation device 50 may perform route guidance using the navigation HMI 52 on the basis of the route on a map. The navigation device 50 may be realized by, for example, a function of a terminal device such as a smartphone or a tablet terminal held by the occupant. The navigation device 50 may transmit the current position and the destination to a navigation server via the communication device 20 and acquire a route similar to the route on a map from the navigation server.

The operation unit 80 includes, for example, an operation switch of a direction indicator, an accelerator pedal, a brake pedal, a shift lever, and other operation elements (not shown). A sensor that detects the amount of operation or the presence or absence of operation is attached to an operation element, and the detection result is output to the driving assistance device 100 or part or all of the traveling driving force output device 200, the brake device 210, and the steering device 220. The steering wheel does not necessarily have an annular shape and may have a shape of an odd-shaped steering wheel, a joystick, a button, or the like. A steering grip sensor is attached to the steering wheel.

In addition to the above, the operation unit 80 includes a steering wheel 82 and a vibrator 84.

The vibrator 84 vibrates the steering wheel 82. For example, the vibrator 84 vibrates based on a command of the driving assistance device 100 and notifies the driver that the vehicle M is approaching a road lane line, that the vehicle M has reached a road lane line, or that the vehicle M has deviated from a road lane line.

The driving assistance device 100 includes, for example, a recognition unit 110, a control unit 115, and an integrated control unit 140. Further, the control unit 115 includes a first departure control unit 120 and a second departure control unit 130. Some or all of these function units are realized by, for example, a hardware processor such as a CPU (Central Processing Unit) executing a program (software). Some or all of these components may be realized by hardware (a circuit unit; including circuitry) such as an LSI (Large Scale Integration), an ASIC (Application Specific Integrated Circuit), an FPGA (Field-Programmable Gate Array), a GPU (Graphics Processing Unit), or an SOC (System on Chip) or may be realized by software and hardware in cooperation. A program may be stored in advance in a storage device (a storage device including a non-transitory storage medium) such as an HDD or a flash memory of the driving assistance device 100, or may be stored in a detachable storage medium such as a DVD or a CD-ROM and be installed in the HDD or the flash memory of the driving assistance device 100 by the storage medium (non-transitory storage medium) being attached to a drive device.

The recognition unit 110 recognizes states such as the position, the speed, and the acceleration of an object that is present around the vehicle M on the basis of information input from the camera 10, the radar device 12, and the LIDAR 14 via the object recognition device 16. The position of the object is recognized, for example, as the position on absolute coordinates using a representative point (a center of gravity, a drive shaft center, or the like) of the vehicle M as an origin and is used in a control. The position of the object may be expressed by a representative point such as the center of gravity or a corner of the object or may be expressed by an area.

The “state” of the object may include the acceleration or jerk of the object, or a “behavior state” (for example, whether or not a lane is being changed or is about to be changed).

For example, the recognition unit 110 recognizes a road lane line around the vehicle M and recognizes a travel lane on the basis of the recognized road lane line. The recognition unit 110 may recognize a travel lane by recognizing a travel road boundary (road boundary), which are not limited to the road lane line but include a road lane line, a road shoulder, a curb, a median strip, a guard rail, and the like. In this recognition, the position of the vehicle M acquired from the navigation device 50 and a process result by the INS may be taken into consideration. The recognition unit 110 recognizes a temporary stop line, an obstacle, red traffic light, a toll gate, other road events, a mark (the speed limit) marked on a road, and a road sign on which the speed limit is marked.

The recognition unit 110 recognizes the position and a posture of the vehicle M with respect to a travel lane when the travel lane is recognized. The recognition unit 110 may recognize, for example, a deviation of a reference point of the vehicle M from a center of a lane and an angle formed with respect to a line connecting the center of the lane in the traveling direction of the vehicle M as a relative position and a posture of the vehicle M with respect to the travel lane. Alternatively, the recognition unit 110 may recognize the position or the like of the reference point of the vehicle M with respect to any side end (a road lane line or a road boundary) of the travel lane as the relative position of the vehicle M with respect to the travel lane.

When it is detected by the recognition unit 110 that the vehicle M is likely to depart from the travel lane, the control unit 115 performs a departure mitigation control of the vehicle M from the travel lane by the first departure control unit 120 or the second departure control unit 130. Further, the control unit 115 determines an end possibility of the departure mitigation control by determining whether or not a predetermined condition is satisfied.

### First Departure Control Unit

The first departure control unit 120 prevents the vehicle M from departing from the road when the driver is controlling the vehicle M. The first departure control unit 120 implements a so-called road departure mitigation function (RDM; Road Departure Mitigation). The first departure control unit 120 executes a first departure mitigation control when the vehicle M is likely to change the lane or depart from a road lane line in the state where a direction indicator is not blinking. Examples of the first departure mitigation control include issuing a warning regarding departure from a road lane line, issuing a warning by vibration of the vibrator 84 of the steering wheel 82, providing steering assistance for causing the vehicle M to approach the center of the lane, and the like.

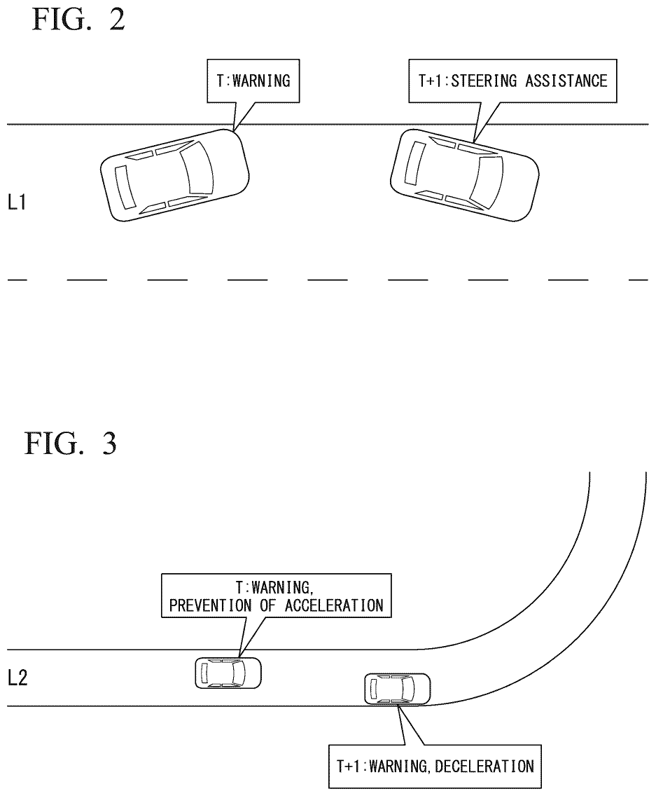

FIG. 2 is a view showing a control executed by the first departure control unit 120. When a condition of the first departure control is satisfied at a time T, the first departure control unit 120 outputs a warning by using the HMI 30. The condition of the first departure control is that the vehicle M reaches a position away from the center of a lane L1 by a predetermined distance or more, that the vehicle reaches a position away from the position of a road lane line of the lane L1 by a predetermined distance, or the like. When the vehicle M is closer to the road lane line at a time T+1 than the position of the vehicle M at the time T, the first departure control unit 120 strengthens the mitigation control further than that at the time T. Strengthening of the mitigation control is that a warning which is further recognized by a driver is issued, that steering assistance which controls the vehicle M to the center of the lane is performed, or the like.

By executing the first departure control as described above, the first departure control unit 120 can prevent the vehicle M from departing from the road.

### Second Departure Control Unit

The second departure control unit 130 prevents the vehicle M from departing from a curved road when the driver is controlling the vehicle M. The second departure control unit 130 implements a so-called curved road departure early warning. The second departure control unit 130 executes a second departure mitigation control in the case where the vehicle M is likely to depart from the curved road when the vehicle M approaches the entrance of the curved road. Examples of the second departure mitigation control include issuing a warning regarding departure from a road lane line of the curved road, issuing a warning by vibration of the vibrator 84 of the steering wheel 82, preventing acceleration of the vehicle M, decelerating the vehicle M, providing steering assistance for causing the vehicle M to approach the center of the lane, and the like.

Whether or not the vehicle is likely to depart is determined by taking part or all of the following target information into consideration. The target information includes, for example, the radius of curvature of the curved road, the degree of change in the curvature of the curved road, an arrival time, turning acceleration, and the like. The arrival time is, for example, an arrival time until the vehicle M reaches a road lane line, which is obtained based on the position of the road lane line with respect to the vehicle M and the state (for example, the position, a traveling direction, the speed, and the acceleration) of the vehicle M. The turning acceleration is, for example, a predicted acceleration to the vehicle M when the vehicle M turns a curved road. For example, when the radius of curvature of the curved road is equal to or less than a first threshold value, the degree of change in curvature is equal to or more than a second threshold value, the arrival time is equal to or less than a third threshold value, and the turning acceleration is equal to or more than a fourth threshold value, it is determined that the vehicle M is likely to depart from the curved road, and the second departure mitigation control is executed.

FIG. 3 is a view showing a control executed by the second departure control unit 130. For example, when the vehicle M travels in a lane L2 and reaches the position by a predetermined distance before the entrance of a curved road that is subject to the second departure mitigation control, and there is a risk that the vehicle M will depart from the curved road, the second departure control unit 130 issues a warning and prevents acceleration to prompt the driver to recognize the curved road. When the driver does not decelerate the vehicle M, the vehicle M travels, and the vehicle M further approaches a road lane line of the curved road, the second departure control unit 130 performs deceleration or performs steering assistance in addition to the issuing of a warning.

By executing the second departure control as described above, the second departure control unit 130 can prevent the vehicle M from departing from the curved road.

In addition to the first departure control and the second departure control described above, the driving assistance device 100 may execute an ACC (Adaptive Cruise Control), a lane keeping control for causing the vehicle M to travel in the center of the lane, or a control for performing an automatic lane change (ALC) that automatically causing the vehicle M to change the lane when a lane change is commanded by the driver.

The integrated control unit 140 controls, for example, each part of the vehicle M such as the communication device 20 or the HMI 30.

The traveling driving force output device 200 outputs a traveling driving force (torque) for the vehicle to travel to a drive wheel. The traveling driving force output device 200 includes, for example, a combination of an internal combustion engine, a motor, a transmission, and the like, and an ECU that controls these elements. The ECU controls the configuration described above in accordance with information input from the driving assistance device 100 or information input from a driving operator.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor in accordance with the information input from the driving assistance device 100 or the information input from the driving operator and outputs a brake torque in accordance with a braking operation to each wheel.

The steering device 220 includes, for example, a steering ECU and an electric motor.

The electric motor changes, for example, a direction of a steering wheel by applying a force to a rack and pinion mechanism. The steering ECU drives the electric motor in accordance with the information input from the driving assistance device 100 or the information input from the driving operator and changes the direction of the steering wheel.

### Outline

The recognition unit 110 of the driving assistance device 100 recognizes a travel lane of the vehicle M. When the recognition unit 110 detects that a self-vehicle is likely to depart from a curve of the travel lane, the control unit 115 performs a curve departure mitigation control of the self-vehicle and determines an end possibility of the curve departure mitigation control.

Here, the control unit 115 determines the end possibility of the curve departure mitigation control by an undershoot state in which a departure state of the self-vehicle is equal to or more than a predetermined state and an overshoot state in which the departure state of the self-vehicle is equal to or less than the predetermined state. At this time, the control unit 115 determines the end possibility of the curve departure mitigation control based on a vehicle body end portion of the self-vehicle and a departure-side lane line of the travel lane which is at a minimal distance with respect to the vehicle body end portion.

Further, the control unit 115 determines that the curve departure mitigation control is ended due to the undershoot state when the distance between the vehicle body end portion and the departure-side lane line of the travel lane which is at the minimal distance is equal to or more than a first predetermined distance toward a departure side with respect to the lane line. Further, the control unit 115 determines that the curve departure mitigation control is ended due to the overshoot state when the distance between the vehicle body end portion and the departure-side lane line of the travel lane which is at the minimal distance is equal to or more than a second predetermined distance toward an opposite side of the departure side with respect to the lane line.

The control unit 115 starts an end determination of the curve departure mitigation control by the overshoot state when the distance between the vehicle body end portion and the departure-side lane line of the travel lane which is at the minimal distance is less than a third predetermined distance toward the opposite side of the departure side with respect to the lane line.

The first predetermined distance and the second predetermined distance described above are an identical value. However, the distances are not necessarily limited to the identical value. For example, the first predetermined distance (for example, 1.5 m) is larger than the second predetermined distance (for example, 0.75 m). Thereby, it is possible to continue the control as much as possible at the outside of the lane in order to mitigate the departure, and when the vehicle returns to a lane center, it is possible to quickly shift to a driving assistance such as a lane keeping control, and it is possible to reduce the inconvenience of the driver by ending a notification sound or the like during the operation of the curve departure mitigation control immediately after the vehicle returns to the inside of the lane.

The third predetermined distance described above is equal to or less than the second predetermined distance.

As described above, the control unit 115 determines the end of the curve departure mitigation control of the vehicle M by the second departure control unit 130 by the undershoot state in which the departure state of the vehicle M is equal to or more than the predetermined state or the overshoot state in which the departure state of the vehicle M is equal to or less than the predetermined state. Hereinafter, the “undershoot state”, the “overshoot state”, and the “determination method of the undershoot state” and the “determination method of the overshoot state” by the control unit 115 are described.

### Undershoot State

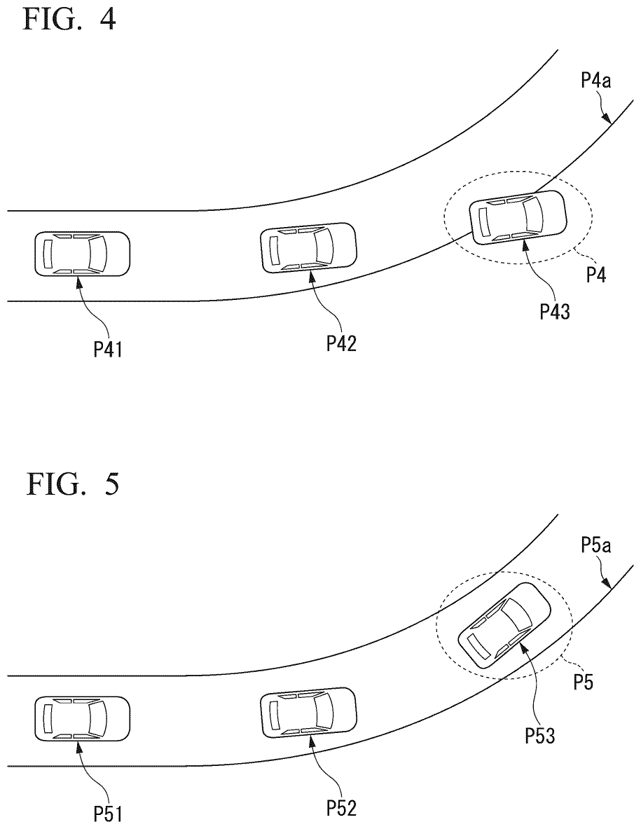

FIG. 4 is a view showing the undershoot state of the vehicle M. The “undershoot state” means a state in which in a curve of a travel lane of the vehicle M, the departure (deviation) from the curve of the travel lane is equal to or more than a predetermined state. Here, the “departure from the curve of the travel lane” means a departure from the travel lane in a direction in which the vehicle M receives a centrifugal force when the vehicle M travels along the curve of the travel lane. Further, the determination of the departure is performed on the basis of a departure-side lane line of the travel lane.

In the case of a left curve with respect to the traveling direction of the vehicle M, the state is determined as the “undershoot state” in the case where, with respect to a departure-side lane line of the travel lane indicated by reference symbol P4a on the right side with respect to the traveling direction, a reference position of the vehicle M is equal to or more than the predetermined state to the outside of the lane line P4a. Similarly, in the case of a right curve with respect to the traveling direction of the vehicle M, the state is determined as the “undershoot state” in the case where the reference position of the vehicle M is equal to or more than the predetermined state with respect to a departure-side lane line of the travel lane on the left side with respect to the traveling direction.

For example, as shown in FIG. 4, when the vehicle M moves from the position of reference symbol P41 to the position of reference symbol P42 and the position of reference symbol P43 on a travel lane, the state becomes the “undershoot state” when the reference position of the vehicle M departs by the predetermined state or more from the departure-side lane line P4a of the travel lane at the position of the reference symbol P43 in the curve of the travel lane. The fact that “the departure from the curve of the travel lane is the predetermined state or more” and “the reference position of the vehicle M” will be separately described.

When the vehicle M becomes the undershoot state, the control unit 115 determines that the curve departure mitigation control is ended. This is because the driver of the vehicle M may intend to move to the departure side of the travel lane, and therefore, the driving of the vehicle M is transferred to the driver.

### Overshoot State

FIG. 5 is a view showing an overshoot state of the vehicle M. The “overshoot state” means a state in which in a curve of a travel lane of the vehicle M, the departure (deviation) from the curve of the travel lane is equal to or less than a predetermined state. Here, the fact that “the departure from the curve of the travel lane is equal to or less than a predetermined state” means a state in which the vehicle M returns from a possibility of a departure from the travel lane in a direction in which the vehicle M receives a centrifugal force when the vehicle M travels along the curve of the travel lane. Further, the determination of whether or not the vehicle returns from the possibility of departure is performed on the basis of a departure-side lane line of the travel lane. In the case of a left curve with respect to the traveling direction of the vehicle M, the state is determined as the “overshoot state” in the case where, with respect to a departure-side lane line of the travel lane indicated by reference symbol P5a on the right side with respect to the traveling direction, the reference position of the vehicle M is equal to or less than the predetermined state at the inside (travel lane side) of the lane line P5a. Similarly, in the case of a right curve with respect to the traveling direction of the vehicle M, the state is determined as the “overshoot state” in the case where, with respect to a departure-side lane line of the travel lane on the left side with respect to the traveling direction, the reference position of the vehicle M is equal to or less than the predetermined state at the inside of the lane line.

For example, as shown in FIG. 5, when the vehicle M moves from the position of reference symbol P51 to the position of reference symbol P52 and the position of reference symbol P53 on a travel lane, the state becomes the “overshoot state” when the reference position of the vehicle M becomes equal to or less than the predetermined state at the inside of the lane line P5a at the position of the reference symbol P53 in the curve of the travel lane. The fact that “a departure from the curve of the travel lane is equal to or less than the predetermined state” and “the reference position of the vehicle M” will be separately described.

When the state becomes the overshoot state, the control unit 115 determines that the curve departure mitigation control is ended. This is because it is possible to determine that the driver of the vehicle M is performing the driving control so as to travel within the travel lane while resisting the centrifugal force applied to the vehicle M by the curve of the travel lane, and therefore the driving of the vehicle M is transferred to the driver.

### Determination Method of Undershoot State

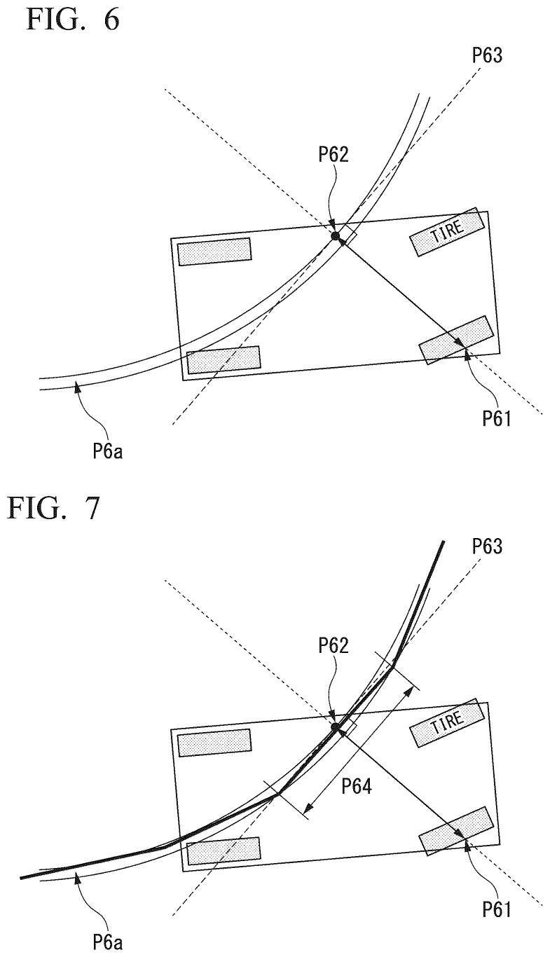

FIG. 6 is a view showing a range indicated by reference numeral P4 in FIG. 4 in more detail. Hereinafter, a determination method of the undershoot state is described with reference to FIG. 6. In FIG. 6, reference numeral P6a indicates a lane line which becomes a departure side in a travel lane curved with respect to the traveling direction. Reference numeral P61 indicates a vehicle body end portion. The vehicle body end portion P61 becomes a reference position of the vehicle body for determining whether or not the state is the “undershoot state” with reference to the lane line P6a. As shown in FIG. 6, the vehicle body end portion is at a position P61 of an outer side surface of a front tire on a far side from the lane line P6a at the time of departure from the lane line P6a. Reference numeral P62 indicates a position which is at a minimal distance to the lane line P6a from the outer side surface of the front tire indicated by the reference numeral P61 which is, for example, a contact position of the outer side surface with a road surface. That is, the position indicated by the reference numeral P62 is an intersection point between the lane line P6a and a perpendicular line to the lane line P6a from the vehicle body end portion indicated by the reference numeral P61. Reference numeral P63 indicates a tangent of the lane line P6a at the position P62.

In the state shown in FIG. 6, when a distance D between the reference numeral P61 and the reference numeral P62 is equal to or more than a first predetermined distance, it is determined that a departure state of the vehicle M is equal to or more than a predetermined state, and the state becomes the “undershoot state”. Further, the “first predetermined distance” is 1.5 m.

As described above, the vehicle body end portion is set at the position P61 of the outer side surface of the front tire on the far side from the lane line P6a at the time of departure from the lane line P6a. This is because the departure from the lane line P6a starts from the outer side surface of the front tire on the departure side, and the front tire serves as a steering wheel for returning from the departure or the like. However, the definition of the position of the vehicle body end portion P61 shown in FIG. 7 is an example and is not limited to this. For example, the position of the reference numeral P61 which becomes the vehicle body end portion may not be located on the outer side surface of the front tire but may be located on the inner side surface of the front tire. Further, the position of the reference numeral P61 which becomes the vehicle body end portion may not be located at the front tire on the far side from the lane line P6a at the time of departure from the lane line P6a but may be located at the front tire on the opposite side. The vehicle body end portion can be preferably located at one of the front tires serving as the steering wheel for returning from the departure or in the vicinity of the front tire.

Further, the “first predetermined distance” of 1.5 m is an example and is not limited to this. The “first predetermined distance” can be determined in consideration of the definition of the reference position of the vehicle M which becomes the vehicle body end portion indicated by reference numeral P61, the vehicle width, and the road width.

FIG. 7 is a view showing another calculation example of the minimal distance between the vehicle body end portion and the lane line. In FIG. 7, the same portion as that in FIG. 6 is denoted by the same reference numeral, and a description thereof is omitted. For simplification of the process, the lane line P6a is not usually defined by a sequence of points but is defined as a series of straight line zones. Therefore, the distance D between the vehicle body end portion P61 and the lane line P6a which is at the minimal distance may be calculated by regarding a straight line zone P64 which is a straight line zone defining the lane line P6a and includes a point P62 closest from the vehicle body end portion P61 as a “tangent”.

### Determination Method of Overshoot State

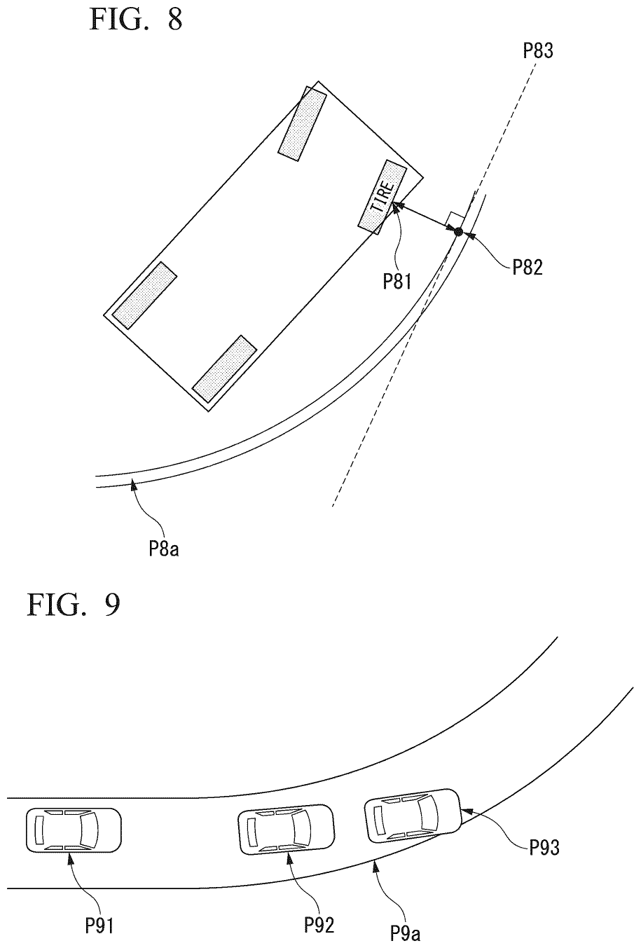

FIG. 8 is a view showing a range indicated by reference numeral P5 in FIG. 5 in more detail. Hereinafter, a determination method of the overshoot state is described with reference to FIG. 8. In FIG. 8, reference numeral P8a indicates a lane line which becomes a departure side in a travel lane curved with respect to the traveling direction. Reference numeral P81 indicates a vehicle body end portion. The vehicle body end portion P81 becomes a reference position of the vehicle M for determining whether or not the state is the “overshoot state” with reference to the lane line P8a. Reference numeral P82 indicates a position at the minimal distance from the vehicle body end portion indicated by the reference numeral P81 to the lane line P8a which becomes the departure side. That is, the position indicated by the reference numeral P82 is an intersection point between the lane line P8a and a perpendicular line to the lane line P8a from the position indicated by the reference numeral P81.

Reference numeral P83 indicates a tangent of the lane line P8a at the position P82.

The definitions of the position of the vehicle body end portion indicated by the reference numeral P81 and the position indicated by the reference numeral P82 are the same as the definitions in the case of the determination of the undershoot state. Thereby, the determination of the “undershoot state” or the “overshoot state” can be made at the same definition position.

In the state shown in FIG. 8, when a distance D between the reference numeral P81 and the reference numeral P82 is equal to or more than a second predetermined distance, it is determined that a departure state in a curve of the vehicle M is equal to or less than a predetermined state, and the state becomes the “overshoot state”. Further, the “second predetermined distance” is 1.5 m.

In a curved travel lane, the curve departure mitigation control of the vehicle M by the second departure control unit 130 is started before the curve. It is assumed that the vehicle M is traveling at the inside of the travel lane opposite to the departure side by the curve in front of the curve as in the position indicated by reference numeral P91 in FIG. 9. In this case, for example, it is assumed that the vehicle M travels substantially linearly from the position of the reference numeral P91 to the position of reference numeral P92. The position indicated by the reference numeral P92 is a position where the travel lane curves. Even if the vehicle M is traveling substantially linearly in the curve as in the position indicated by the reference numeral P92, the distance between the vehicle body end portion and the lane line P9a of the travel lane which is at the minimal distance can be equal to or more than the “second predetermined distance”. In this case, an unintended end of the curve departure mitigation control may occur. Due to the unintended end of the curve departure mitigation control, the vehicle M may continue to move to the position of reference numeral P93, and the departure of the vehicle M in the curve may occur.

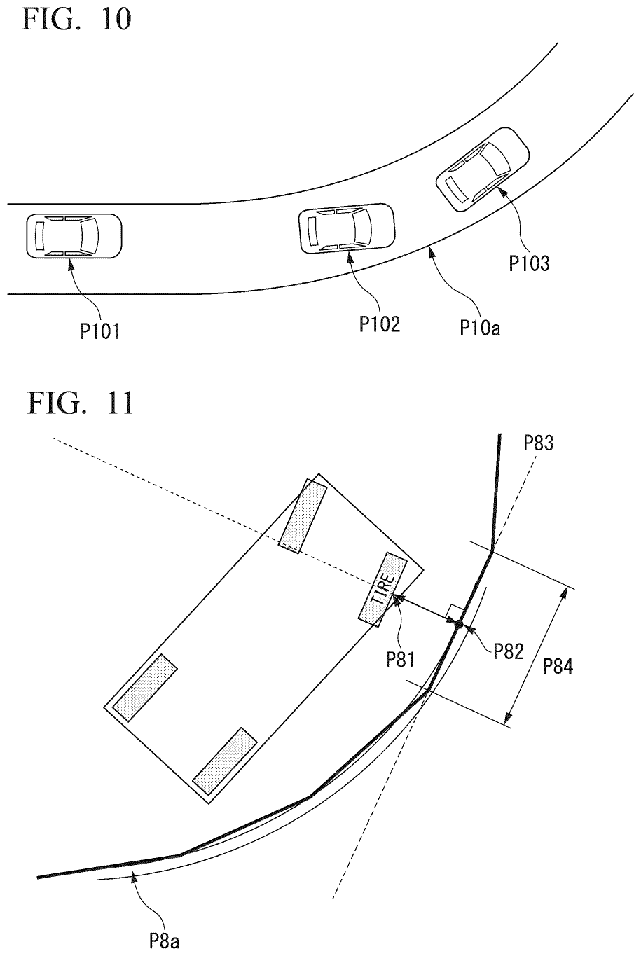

Therefore, as indicated by reference numeral 102 in FIG. 10, after the distance between the vehicle body end portion and the lane line of the travel lane which is at the minimal distance becomes less than a “third predetermined distance” on an opposite side of the departure side of the lane line, that is, on a travel lane side, the determination of the overshoot state using the second predetermined distance described above is performed. Thereby, even when the vehicle M is traveling at the inside of the travel lane which is the opposite side of the departure side by the curve before the curve as in the position indicated by reference numeral P101 in FIG. 10, the determination of the overshoot state can be started after the vehicle M approaches a lane line P10a in the curve as in the position of the reference numeral P102. As a result, an “overshoot state” which is a state of having returned from the possibility of departure as in the position indicated by reference numeral P103 can be accurately detected. Here, the “third predetermined distance” is 1.5 m.

As described above, the definition of the position of the vehicle body end portion P81 shown in FIG. 8 and the definition of the position indicated by the reference symbol P81 can be preferably the same as the definition in the case of the determination of the undershoot state but are not limited to this. The definition of the position for determining the “overshoot state” may be different from the definition of the position for determining the “undershoot state”.

Further, both of the “second predetermined distance” and the “third predetermined distance” are 1.5 m, but is not limited to this, and may be a different value from each other. Additionally, the “second predetermined distance” and the “third predetermined distance” may be a value other than 1.5 m. The “second predetermined distance” and the “third predetermined distance” may be determined in consideration of the definition of the reference position of the vehicle M which is at the vehicle body end portion indicated by the reference numeral P81 in FIG. 8, a vehicle width, a road width, and the like. However, the “third predetermined distance” is a value equal to or less than the “second predetermined distance”. Thereby, it is possible to accurately detect the state of having returned from the possibility of the departure of the vehicle M due to the curve as shown in FIG. 10.

FIG. 11 is a view showing another calculation example of a minimal distance between a vehicle body end portion and a lane line. In FIG. 11, the same portion as that in FIG. 8 is denoted by the same reference numeral, and a description thereof is omitted. As described in FIG. 7, for simplification of the process, the lane line P8a is not usually defined by a point sequence but is defined as a series of straight line zones. Therefore, the distance between the vehicle body end portion P81 and the lane line P8a which is at the minimal distance may be calculated by regarding a straight line zone P84 which is a straight line zone defining the lane line P8a and includes a point P82 closest from the vehicle body end portion P81 as a “tangent”.

### Determination Flow

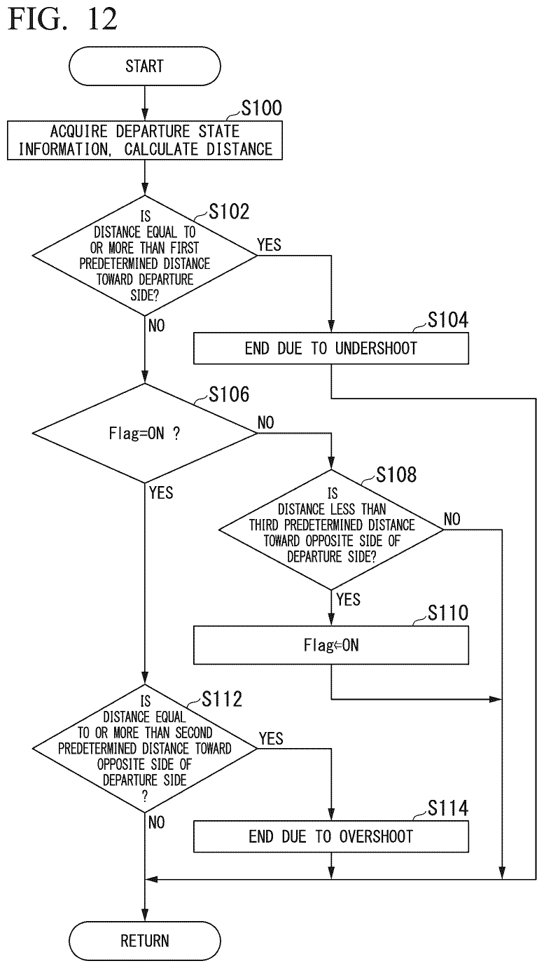

Next, an operation of the determination of an end possibility of the curve departure mitigation control by the control unit 115 of the driving assistance device 100 after the curve departure mitigation control of the self-vehicle is started is described. FIG. 12 is a flowchart showing an example of a flow of a determination of an end possibility of the curve departure mitigation control executed by the control unit 115. When the recognition unit 110 recognizes the curve of the travel lane of the vehicle M and detects that the self-vehicle is likely to depart from the curve of the travel lane, the control unit 115 starts the curve departure mitigation control by the second departure control unit 130. When the curve departure mitigation control is started, the control unit 115 calls a determination routine of FIG. 12 and thereby performs the determination of the end possibility of the curve departure mitigation control. Further, the control unit 115 repeatedly calls the determination routine until it is determined that the curve departure mitigation control is ended. The determination flow shown in FIG. 12 is provided as a process routine which is part of a process by the control unit 115.

When starting the curve departure mitigation control by the second departure control unit 130, the control unit 115 resets a flag indicating whether or not an overshoot determination start criterion is satisfied, that is, sets a “flag” to “OFF” (a value “0”). When the “flag” is “ON” (a value “1”), it is indicated that the overshoot determination start criterion is satisfied.

On the other hand, when the “flag” is “OFF”, it is indicated that the overshoot determination start criterion is not satisfied.

The control unit 115 acquires departure state information relating to a position relationship between the vehicle M and a departure-side lane line of the travel lane from the recognition unit 110. Further, the control unit 115 calculates a distance D between the vehicle body end portion of the vehicle M and the departure-side lane line of the travel lane which is at the minimal distance with respect to the vehicle body end portion (Step S100). The recognition unit 110 recognizes information relating to the departure-side lane line in the curved travel lane and information on the position relationship between the lane line and the vehicle M. In this recognition, the recognition unit 110 recognizes information on the position relationship between the vehicle M and the lane line using a reference point of the vehicle M, for example, using a vehicle head center as the reference point, a direction of the vehicle M, and the like. The control unit 115 acquires a recognition result relating to the departure-side lane line of the travel lane by the recognition unit 110 and information on the position relationship between the lane line and the vehicle M, the direction of the vehicle M, and the like and obtains the distance D. The information relating to the position relationship between the reference point of the vehicle M such as the vehicle head center and the vehicle body end portion when the distance D is obtained is set in advance in the control unit 115. The control unit 115 calculates the distance D using the information. At this time, the control unit 115 also determines whether the vehicle body end portion is on the departure side of the lane line, or the vehicle body end portion is on the opposite side of the departure side of the lane line, that is, on the travel lane side. The control unit 115 performs the determination of Steps S102, S108, and S112 described below by using the calculated distance D and a determination result of whether or not the vehicle body end portion is on the departure side of the lane line.

The control unit 115 determines whether a departure state of the vehicle M is equal to or more than a predetermined state by using the calculated distance D and the determination result of whether the vehicle body end portion is on the departure side of the lane line, or is on the opposite side of the departure side of the lane line (Step S102). Specifically, as described above, the control unit 115 performs the determination by whether or not the distance D is equal to or more than a first predetermined distance toward the departure side of the lane line.

When it is determined that the distance D is equal to or more than the first predetermined distance toward the departure side of the lane line (Step S102: Yes), the control unit 115 determines that the curve departure mitigation control is ended due to the “undershoot state” (Step S104).

On the other hand, when it is determined that the distance D is not equal to or more than the first predetermined distance toward the departure side of the lane line (Step S102: No), the control unit 115 determines whether or not the “flag” indicating whether or not the overshoot determination start criterion is satisfied is “ON” (Step S106).

When the “flag” is not “ON” (Step S106: No), the control unit 115 determines whether a determination start condition of the overshoot state is satisfied (Step S108). Specifically, the control unit 115 determines whether the distance D is less than a third predetermined distance on the opposite side of the departure side of the lane line. From the relationship with Step S102, when the distance D is less than the third predetermined distance on the opposite side opposite of the departure side of the lane line and the distance D is less than the first predetermined distance toward the departure side of the lane line, the condition in Step S108 is satisfied.

When it is determined that the distance D is less than the third predetermined distance on the opposite side of the departure side of the lane line (Step S108: Yes), the control unit 115 changes the “flag” to “ON” so as to indicate that the determination start criterion of the overshoot state is satisfied (Step S110).

When the “flag” is “ON” in Step S106 (Step S106: Yes), since the overshoot determination start criterion is satisfied, the control unit 115 determines whether the departure state of the vehicle M is equal to or less than the predetermined state (Step S112). Specifically, the control unit 115 performs the determination by whether the distance D is equal to or more than the second predetermined distance toward the opposite side of the departure side of the lane line.

When it is determined that the distance D is equal to or more than the second predetermined distance toward the opposite side to the departure side of the lane line (Step S112: Yes), the control unit 115 determines that the curve departure mitigation control is ended due to the “overshoot state”.

When the determination of the end of the curve departure mitigation control due to the “undershoot state” in Step S104 is made, or the determination of the end of the curve departure mitigation control due to the “overshoot state” in Step S112 is made, the control unit 115 transfers the control to the process routine of the control unit 115 that has called the determination routine of FIG. 12 together with the information of the end of the curve departure mitigation control. At this time, the control unit 115 ends the curve departure mitigation control by the second departure control unit 130 based on the result of the determination routine shown in FIG. 12.

On the other hand,
when it is determined that the distance D is not less than the third predetermined distance on the opposite side of the departure side of the lane line (Step S108: No);
when the “flag” is changed to “ON” (Step S110); or
when it is determined that the distance D is not equal to or more than the second predetermined distance toward the opposite side of the departure side of the lane line (Step S112: No),
the control is transferred to the process routine of the control unit 115 that has called the determination routine of FIG. 12 in order to repeat the determination routine shown in FIG. 12. At this time, the control unit 115 calls the determination routine of FIG. 12 again. By the re-calling, the control unit 115 performs an end determination of the curve departure mitigation control based on a new recognition result of a lane line by the recognition unit 110 and new information relating to the position relationship between the reference point of the vehicle M and the lane line or the like.

According to the embodiment described above, the driving assistance device 100 performs the end determination of the curve departure mitigation control by the determination of the undershoot state or the overshoot state on the basis of the departure-side vehicle body end portion of the self-vehicle and the departure-side lane line of the travel lane which is at the minimal distance with respect to the vehicle body end portion. Thereby, even when the self-vehicle departs from the curve, by performing the determination on the basis of the nearest lane line, it is possible to prevent the end condition of the curve departure mitigation control from being immediately established by a departure angle of the curve. Further, by using the departure-side lane line of the travel lane as the basis, it is possible to uniform the determination of the overshoot and the undershoot, and as a result, it becomes possible to appropriately end a mitigation control of road departure in a curve.

The embodiment is described using an example in which the undershoot state or the overshoot state is determined based on the distance between the vehicle body end portion and the departure-side lane line of the curved travel lane which is at the minimal distance. Alternatively, the determination may be made based on the time of departure from the departure-side lane line of the travel lane. For example, the undershoot state may be determined based on the time when the vehicle body end portion departs from the departure-side lane line. Further, the overshoot state may be determined when the vehicle head center of the self-vehicle returns to the vicinity of the center of the travel lane within a predetermined time after the vehicle body end portion departs from the departure-side lane line or after the vehicle body end portion approaches the departure-side lane line. The time as the determination reference at this time may be determined using one or more of the speed of the vehicle M, the curvature or the gradient of the curve of the travel lane, and the like as a parameter.

Further, the undershoot state or the overshoot state may be determined in consideration of not only the distance between the vehicle body end portion and the departure-side lane line of the curved travel lane which is at the minimal distance but also the time during which a determination criterion relating to the distance is maintained.

Further, the embodiment is described using an example in which the determination of the overshoot state is started after the determination start condition of the overshoot state is satisfied. This can be preferable for avoiding an unexpected end of the curve departure mitigation control, but the determination of the overshoot state may be started without providing the determination start condition of the overshoot state.

The embodiment described above can be expressed as follows.

A vehicle control device includes: a storage device storing a program; and a hardware processor and is configured to: by the hardware processor executing a program stored in the storage device, recognize a curve of a travel lane of a self-vehicle; perform a curve departure mitigation control of the self-vehicle when it is detected that the self-vehicle is likely to depart from the curve of the travel lane; and determine an end possibility of the curve departure mitigation control based on a vehicle body end portion of the self-vehicle and a departure-side lane line of the travel lane which is at a minimal distance with respect to the vehicle body end portion when determining the end possibility by an undershoot state in which a departure state of the self-vehicle is equal to or more than a predetermined state and an overshoot state in which the departure state of the self-vehicle is equal to or less than the predetermined state.

Although the embodiment of the present invention has been described, the present invention is not limited to the embodiment described above, and various modifications and substitutions can be made without departing from the scope of the present invention.

What is claimed is:

1. A vehicle control device comprising:
a recognition unit that recognizes a curve of a travel lane of a self-vehicle; and
a control unit that performs, when the recognition unit detects that the self-vehicle is likely to depart from the curve of the travel lane, a curve departure mitigation control of the self-vehicle and determines an end possibility of the curve departure mitigation control,
wherein the control unit
determines the end possibility by an undershoot state in which a departure state of the self-vehicle is equal to or more than a predetermined state and an overshoot state in which the departure state of the self-vehicle is equal to or less than the predetermined state, and
determines the end possibility based on a vehicle body end portion of the self-vehicle and a departure-side lane line of the travel lane which is at a minimal distance with respect to the vehicle body end portion.

2. The vehicle control device according to claim 1,
wherein the control unit
determines that the curve departure mitigation control is ended due to the undershoot state when a distance between the vehicle body end portion and the departure-side lane line of the travel lane which is at the minimal distance is equal to or more than a first predetermined distance toward a departure side with respect to the lane line, and
determines that the curve departure mitigation control is ended due to the overshoot state when the distance between the vehicle body end portion and the departure-side lane line of the travel lane which is at the minimal distance is equal to or more than a second predetermined distance toward an opposite side of the departure side with respect to the lane line.

3. The vehicle control device according to claim 2,
wherein the control unit starts an end determination of the curve departure mitigation control by the overshoot state when the distance between the vehicle body end portion and the departure-side lane line of the travel lane which is at the minimal distance is less than a third predetermined distance toward the opposite side of the departure side with respect to the lane line.

4. The vehicle control device according to claim 2,
wherein the first predetermined distance and the second predetermined distance are an identical value.

5. The vehicle control device according to claim 3,
wherein the third predetermined distance is equal to or less than the second predetermined distance.

6. A vehicle control method comprising:
by way of a computer,
recognizing a curve of a travel lane of a self-vehicle;
performing a curve departure mitigation control of the self-vehicle when it is detected that the self-vehicle is likely to depart from the curve of the travel lane; and
determining an end possibility of the curve departure mitigation control based on a vehicle body end portion of the self-vehicle and a departure-side lane line of the travel lane which is at a minimal distance with respect to the vehicle body end portion when determining the end possibility by an undershoot state in which a departure state of the self-vehicle is equal to or more than a predetermined state and an overshoot state in which the departure state of the self-vehicle is equal to or less than the predetermined state.

7. A computer-readable non-transitory storage medium storing a program that causes a computer to:
recognize a curve of a travel lane of a self-vehicle;
perform a curve departure mitigation control of the self-vehicle when it is detected that the self-vehicle is likely to depart from the curve of the travel lane; and
determine an end possibility of the curve departure mitigation control based on a vehicle body end portion of the self-vehicle and a departure-side lane line of the travel lane which is at a minimal distance with respect to the vehicle body end portion when determining the end possibility by an undershoot state in which a departure state of the self-vehicle is equal to or more than a predetermined state and an overshoot state in which the departure state of the self-vehicle is equal to or less than the predetermined state.
